(19) United States
(12) Patent Application Publication
(10) Pub. No.: US 2025/0199310 A1
(43) Pub. Date: Jun. 19, 2025

(54) COLLIMATOR-BASED FIELD-OF-VIEW CALIBRATION FOR AUGMENTED REALITY DISPLAY SYSTEMS

(71) Applicant: GOOGLE LLC, Mountain View, CA (US)

(72) Inventors: Nan Ma, Oakville (CA); Ian Andrews, Kitchener (CA)

(21) Appl. No.: 18/980,780

(22) Filed: Dec. 13, 2024

Related U.S. Application Data
(60) Provisional application No. 63/610,488, filed on Dec. 15, 2023.

(51) Int. Cl. G02B 27/01

(52) U.S. Cl. CPC G02B 27/0149; G02B 27/0172; G02B 2027/0154; G02B 2027/0178

(57) ABSTRACT

Systems, techniques, and devices are provided for calibrating wearable augmented-reality display systems. A support frame is configured to be removably coupled to a wearable augmented-reality display system. The support frame is coupled to a collimator comprising one or more collimating optical elements and to a graticule, which aligns with one or more alignment indicators emitted from the wearable augmented-reality display system.

### BACKGROUND

Augmented reality (AR) technology has advanced rapidly, bringing forth a new generation of AR display systems designed to overlay digital content onto the real world. These AR display systems (typically configured as wearable headsets) typically comprise left and right displays that project images into a user's eyes, creating an immersive experience. One aspect of successfully operating such AR display systems is maintaining precise alignment between the left and right displays to ensure a coherent and comfortable visual experience. Misalignments, even subtle ones, can lead to user discomfort, including eye strain and headaches, and degrade the quality of the AR experience.

Several factors contribute to misalignment in AR display systems. Thermal fluctuations, mechanical stresses, and natural aging of the headset materials can all cause slight shifts in the position or orientation of the display elements. Current AR headsets, especially those striving for lightweight and eyeglasses-like designs, face significant challenges in maintaining stable alignment over time.

Existing solutions to this problem typically involve the use of rigid structures or additional hardware components to stabilize the displays. However, these solutions have inherent limitations. Rigid structures add weight and bulk to the headset, detracting from user comfort and the overall experience. Additional hardware components, such as sensors and actuators for real-time alignment adjustments, increase the complexity, power consumption, and cost of the headset.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates an example wearable AR display device in accordance with various embodiments.

FIG. 2 illustrates a side view of a collimator designed for field of view (FOV) calibration in accordance with some embodiments.

FIG. 3 depicts an example of a calibration process in accordance with some embodiments.

FIG. 4 illustrates an example configuration of a collimator in the form of a multi-lens optical system designed for FOV calibration of an AR display system, in accordance with some embodiments.

FIG. 5 illustrates a monolithic catadioptric lens as part of a collimator system for FOV calibration of a wearable AR display system, in accordance with some embodiments.

FIG. 6 illustrates a holographic collimator system that can be used to generate an alignment pattern for FOV calibration of an AR display system, in accordance with some embodiments.

FIG. 7 illustrates a retroreflector used in conjunction with a diffractive waveguide of a wearable AR display system, in accordance with some embodiments.

FIG. 8 illustrates an operational routine such as may be performed by a collimating alignment apparatus in accordance with one or more embodiments.

### DETAILED DESCRIPTION

Current solutions for aligning and/or calibrating displays in wearable AR display systems fail to provide a practical means for users to recalibrate those display systems. In most cases, AR display systems with misaligned displays must be returned to the manufacturer or a service center for realignment, causing inconvenience to the user and additional service costs.

Embodiments of techniques described herein provide a user-operable calibration device for wearable AR display systems, enabling a user-initiated and precise alignment of left and right displays. Such techniques address AR display system misalignment due to (as non-limiting examples) thermal fluctuations, mechanical stresses, and aging, enhancing user comfort and visual experience. Via various embodiments, such techniques are adaptable to various display AR systems, offering a cost-effective and user-friendly method for maintaining optimal display alignment.

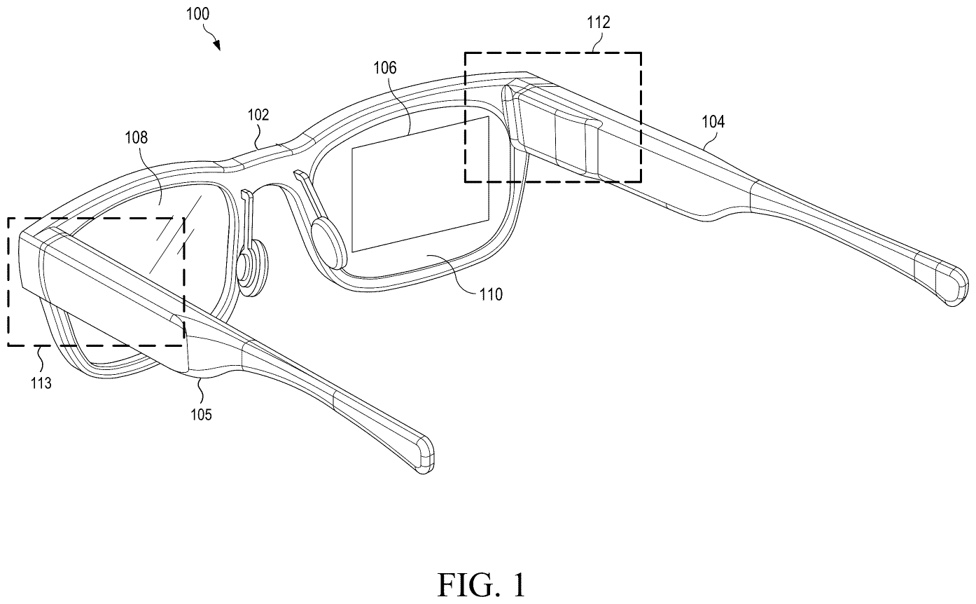

FIG. 1 is a diagram illustrating a rear perspective view of an example wearable AR display (WARD) system 100 in accordance with some embodiments. The WARD system 100 includes a support frame 102 to removably mount to a head of a user. In the depicted embodiment, the support frame 102 includes temple arms 104, 105. The temple arm 104 houses a laser projection system, micro-display (e.g., micro-light emitting diode (LED) display), or other light engine configured to project display light representative of images toward the eye of a user, such that the user perceives the projected display light as a sequence of images displayed in an FOV area 106 at one or both of lens elements 108, 110 supported by the support frame 102 and using one or more display optics. The display optics may include one or more instances of optical elements selected from a group that includes at least: a waveguide (references to which, as used herein, include and encompass both light guides and waveguides), a holographic optical element, a prism, a diffraction grating, a light reflector, a light reflector array, a light refractor, a light refractor array, or any other light-redirection technology as appropriate for a given application, positioned and oriented to redirect the AR content from the light engine towards the eye of the user. In some embodiments, the support frame 102 further includes various sensors, such as one or more front-facing cameras, rear-facing cameras (e.g., for eye tracking), other light sensors, motion sensors, accelerometers, and the like. The support frame 102 further can include one or more radio frequency (RF) interfaces or other wireless interfaces, such as a Bluetooth(™) interface, a WiFi interface, and the like.

The support frame 102 further can include one or more batteries or other portable power sources for supplying power to the electrical components of the WARD system 100. In some embodiments, some or all of these components of the WARD system 100 are fully or partially contained within an inner volume of support frame 102, such as within the arm 104 in region 112. Similarly, the arm 105 may house some or all corresponding components of the WARD system 100 (including, for example, a light engine and/or one or more optical elements) in region 113, to be used in conjunction with the corresponding FOV area (not shown) of lens element 108. In the illustrated implementation, the WARD system 100 utilizes an eyeglasses form factor. However, the WARD system 100 is not limited to this form factor and thus may have a different shape and appearance from the eyeglasses frame depicted in FIG. 1.

The lens elements 108, 110 are used by the WARD system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the WARD system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

In various embodiments, non-limiting example display architectures include scanning laser projector and holographic optical element combinations, side-illuminated optical light guide displays, pin-light displays, or other wearable AR display system. The term light engine as used herein is not limited to referring to a singular light source, but can also refer to a plurality of light sources, and can also refer to a light engine assembly (LEA). A light engine assembly may include some components which enable the light engine to function, or which improve operation of the light engine. As one example, a light engine may include a light source, such as a laser or a plurality of lasers. The light engine assembly may additionally include electrical components, such as driver circuitry to power the at least one light source. The light engine assembly may additionally include optical components, such as collimation lenses, a beam combiner, or beam shaping optics. In certain embodiments, the LEA additionally includes beam redirection optics, such as least one MEMS mirror operated to scan light from at least one laser light source, such as in a scanning laser projector. In the above example, the LEA includes a light source and also optical components, which accept the output from at least one light source and produce conditioned display light to convey AR content. In various embodiments, components in the light engine assembly are included in a housing of the light engine assembly, are affixed to a substrate of the light engine assembly (e.g., a printed circuit board or similar), or are separately mounted components of a wearable AR display.

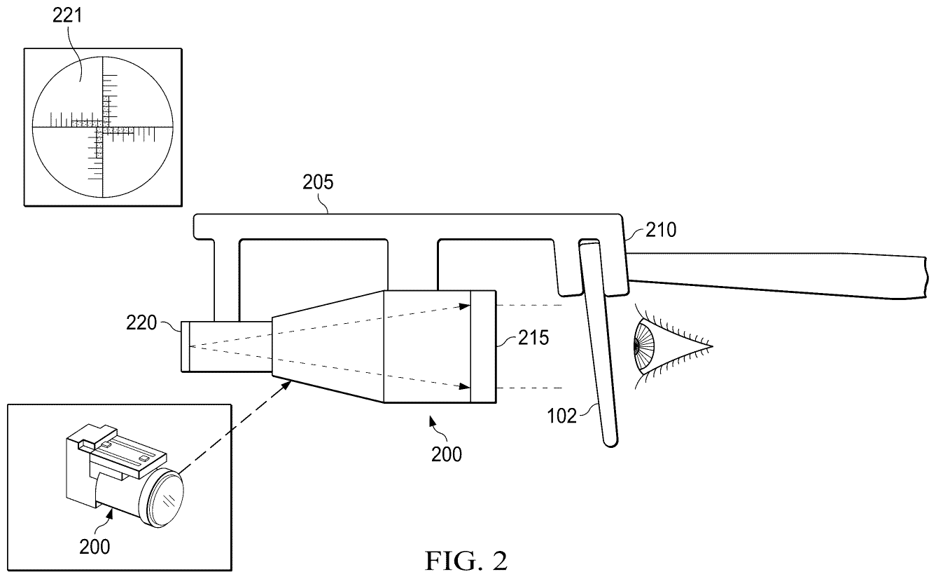

FIG. 2 presents a side view of a collimating alignment apparatus (CAA) 200 designed for FOV calibration for the example WARD system 100, in accordance with some embodiments. In the depicted embodiment, the CAA 200 includes a clamp 210 that secures the collimating alignment apparatus 200 to support frame 102 of the WARD system 100. In certain embodiments, the support frame 102 operates as a datum lens frame, a precise and stable reference structure that serves as a standardized alignment base. In other embodiments, the CAA 200 is removably secured to one or more other fixed reference points on the WARD system, such as by using an optical element (e.g., a lens, reflector, waveguide, and the like) of the removably coupled WARD system as a reference plane. In both scenarios, the CAA 200 is mounted consistently relative to the optical elements of the WARD system 100, maintaining alignment accuracy.

In the depicted embodiment, the clamp 210 connects to a support frame 205, which extends from the support frame 102 via the clamp 210 to securely position the CAA 200 relative to the WARD system 100. This configuration improves stability and precision of the CAA 200 during calibration, allowing it to remain fixed in the intended position. In various embodiments, the support frame 102 is adjustable to accommodate multiple distinct wearable augmented-reality display (WARD) systems having multiple distinct physical parameters.

A collimating lens 215 is coupled to the support frame 205 and positioned to project an optical alignment pattern 221 via a graticule 220. As used herein, a graticule refers to a visual reference pattern, often in the form of crosshairs, grids, concentric circles, or other markings, that is superimposed on the optical field of an instrument to aid in alignment and measurement. In the context of WARD system calibration, the graticule 220 serves as a stable reference pattern within the CAA 200, allowing the user to align projected images (e.g., crosshairs and/or other alignment markings) from the respective left and right light engine assemblies to achieve precise calibration.

In the depicted embodiment, the optical alignment pattern 221 (which typically includes markings such as a crosshair and/or additional alignment markings) is projected into the user's eyes via both left and right light engine assemblies (LEAs), simulating the viewing experience of an object located at a predetermined distance (e.g., two meters (2 m)). This projected optical alignment pattern 221 enables the user to merge these instances of the optical alignment pattern 221 using the CAA 200, adjusting the displayed instances until the LEA-projected crosshairs align precisely with those from the collimator. In certain embodiments, the support frame 205 is coupled to two collimating lenses (both operationally identical to collimating lens 215, one corresponding to each eye) such that the two collimating lenses are respectively configured to project the alignment pattern 221 towards the right and left eyes of the user.

In some embodiments, the support frame 102 includes a user interface to facilitate adjustment of the position or orientation of the CAA 200 relative to the AR display system 100, such as one or more user controls to align instances of the alignment pattern 221 projected towards the eyes of the user. As non-limiting examples, the user interface may include one or more mechanical adjustment mechanisms, such as dials, sliders, or knobs, to enable fine-tuning of the collimator's placement along one or more axes. As another example, the user interface may be implemented as an electronic adjustment system, such as motorized actuators controlled via buttons, a touchscreen, or a companion application on a communicatively connected device (e.g., on a mobile computing device such as a smart phone, on the AR display system itself, or on other suitable device). These adjustment mechanisms allow the user to ensure precise alignment of the collimator 200 with the optical components of the AR display system 100, improving the accuracy of the calibration process.

In the depiction of FIG. 2, an inset image illustrates an embodiment of the CAA 200, highlighting its compact form factor. This design facilitates easy handling and convenient calibration by users without requiring professional assistance.

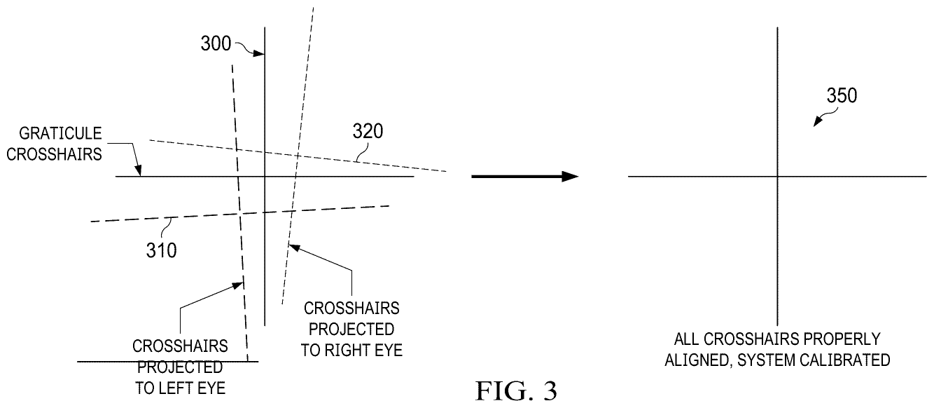

FIG. 3 illustrates an example calibration process for the WARD system 100 using the CAA 200, in accordance with some embodiments. In the depicted example, crosshairs 310, 320 are respectively projected by the WARD system's left- and right-hand light engine assemblies (LEAs) to be aligned with reference crosshairs 300, which are provided via graticule 220 of the CAA 200. On the left side of the figure, the initial misalignment of the crosshairs is depicted, where the graticule crosshairs 300 do not coincide with the crosshairs projected to the left eye 310 and the crosshairs projected to the right eye 320. This misalignment typically results in a distorted or uncomfortable visual experience, as the projected images from each LEA are not properly calibrated.

The calibration process involves adjusting the WARD system 100, either digitally or physically, until the projected crosshairs 310 and 320 converge with the graticule crosshairs 300, as shown on the right side of FIG. 3. In this aligned configuration, all sets of crosshairs overlap at position 350 to form a single unified crosshair, indicating that the system is properly calibrated—e.g., that the AR content displayed to the user is visually coherent when superimposed over the real-world environment.

In operation, to align the projected instances of the optical alignment pattern 221 users can modify the calibration of the WARD system 100 through either digital or physical adjustments. In some embodiments, the WARD system 100 provides software-based based controls accessible via a user interface or companion software application, allowing users to adjust the alignment of the LEA-projected crosshairs digitally. By altering parameters such as angle, position, or convergence of the projected images through these software controls, users can align the crosshairs with the reference pattern of the graticule 220 within the CAA 200. In other embodiments, the WARD system 100 allows for manual, physical adjustments to the position or orientation of the light engine assemblies (LEAs). This may involve the use of one or more physical fine-tuning mechanisms, such as screws, sliders, or dials, positioned on the support frame 102 or within the temple arms 104, 105, enabling the user to adjust the LEAs until the projected crosshairs align precisely with the graticule's reference pattern.

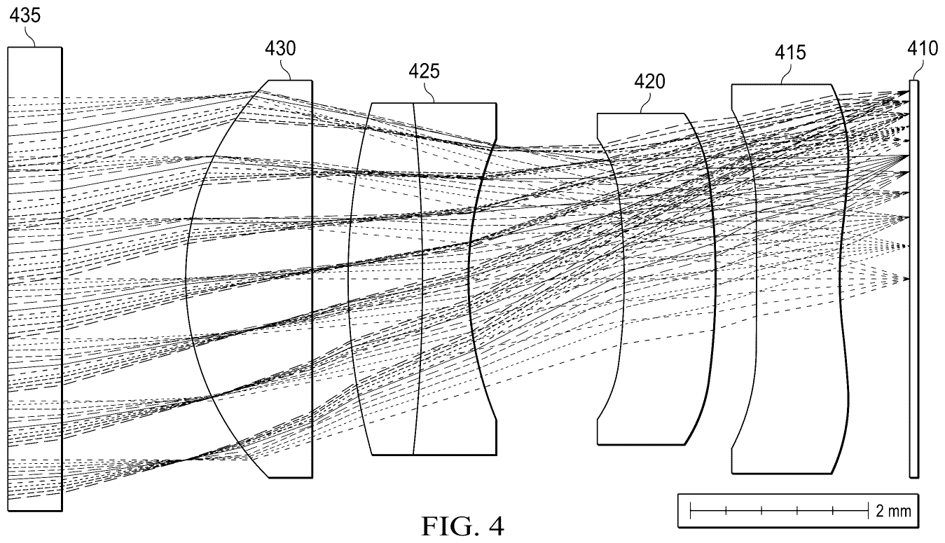

FIG. 4 illustrates an example configuration of a collimator 400 in the form of a multi-lens optical system that directs the display light from a light engine assembly 410 to produce a precise calibration pattern for use in calibration of an AR display system (e.g., WARD system 100), in accordance with some embodiments. The LEA 410 serves as the light source initiating projection of display light effectuating the calibration pattern (e.g., optical alignment pattern 221) through a sequence of lenses arranged in series, each contributing to the projection of the calibration pattern to facilitate accurate alignment of the AR system's displays.

In the depicted embodiment, the display light emitted by the LEA 410 passes through a sequence of lens elements 415, 420, 425, 430, and 435. Each of these lenses modifies one or more of the direction, focus, and collimation of the display light, creating a controlled path with minimal divergence. As the display light progresses through these elements, the lenses 415, 420, 425, 430, and 435 operate in tandem to transform the display light from the LEA 410 into a coherent, parallel beam that can project a clear and stable optical alignment pattern at a target focal distance.

The final lens element 435 of the series serves as the last collimating component, producing the output display light as a precisely aligned beam. In some embodiments, lens element 435 may correspond to one of the lens elements 108 or 110 of the WARD system 100 in FIG. 1, integrating the collimator 400 into the AR display's optical pathway. In such embodiments, lens element 435 both completes the collimation of the light for calibration purposes and functions as part of the display optics that overlays augmented reality content onto the real-world view.

A 2 mm scale reference at the bottom of FIG. 4 illustrates the relative compactness of the depicted embodiment, enabling integration into wearable AR systems without significant bulk.

It should be noted that the specific arrangement of lenses depicted in FIG. 4 is one example of a multi-lens configuration that can achieve the desired collimation effect. Alternative configurations and embodiments in accordance with techniques described herein may also be employed to achieve the necessary alignment and collimation to project a clear, stable optical alignment pattern.

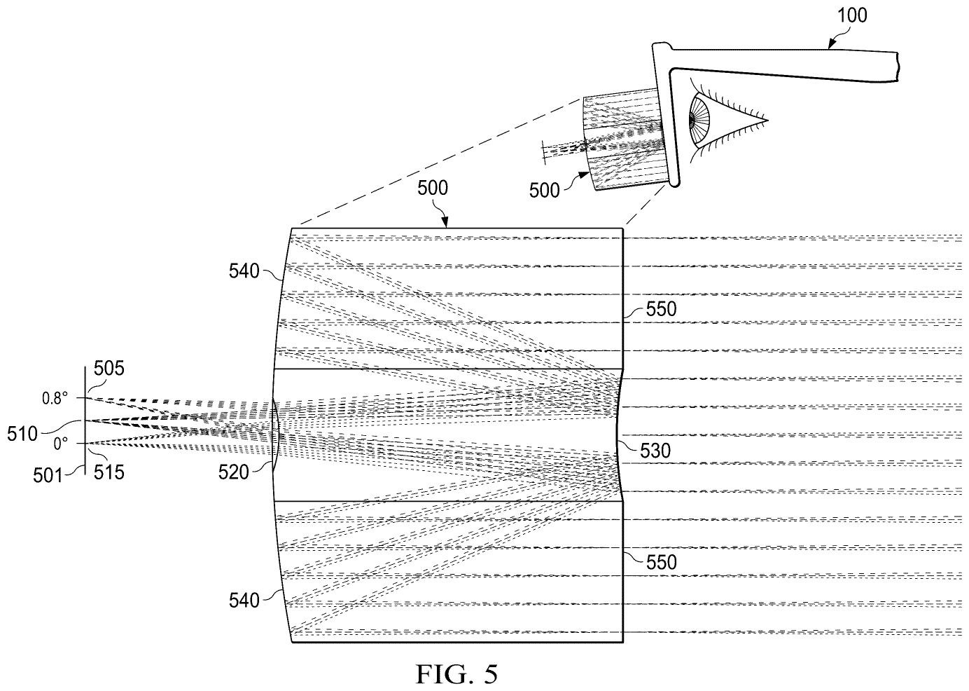

FIG. 5 illustrates a monolithic catadioptric optical system, forming part of a collimator apparatus 500 that is configured for FOV calibration of the WARD system 100, in accordance with some embodiments. In certain configurations and scenarios, the collimator apparatus 500 may be used as part of the CAA 200 or other collimating alignment apparatus, such as to form some or all of collimating lens 215 from FIG. 2. As used herein, a catadioptric lens is an optical lens system that combines refractive elements (e.g., lenses) and reflective elements (e.g., mirrors) to form an image. Such catadioptric systems therefore utilize both refractive and reflective components to provide enhanced optical paths for more complex or compact system designs. The depicted embodiment combines refractive and reflective optical elements to project a precise optical alignment pattern, enabling accurate alignment of the left and right displays of the AR system.

At the input of the collimator apparatus 500 is a light engine assembly (LEA) 501, which emits three distinct display lights corresponding to the red, green, and blue (RGB) components of the alignment pattern. These display lights are emitted at specific angular offsets relative to the baseline of the blue light. In the illustrated example, the blue display light at 515 defines the 0-degree baseline; the green display light at 510 is offset by 0.4 degrees, and the red display light at 505 is offset by 0.8 degrees. This angular separation allows the collimator to provide proper convergence of the RGB light components within the optical system.

The RGB display light emitted by the LEA 501 enters the collimator apparatus 500 through an incoupling aperture 520, which directs the display light into the subsequent optical pathway: after passing through the incoupling aperture 520, the display light is reflected off each of the opposing reflective surfaces 530 and 540 in turn. The resultingly redirected light is thereby collimated into a parallel beam and emitted from the collimator apparatus 500 as a coherent optical alignment pattern at the outcoupling surface 550. This alignment pattern is visible to the user through the WARD system's optical elements (e.g., lens elements 108 or 110 in FIG. 1) and serves as a stable reference for calibration. Still referring to FIG. 5, and as shown in the upper-left inset diagram, the collimator assembly 500 integrates with the WARD system 100, projecting the alignment pattern directly to the user's eye for alignment with the reference graticule-provided alignment pattern.

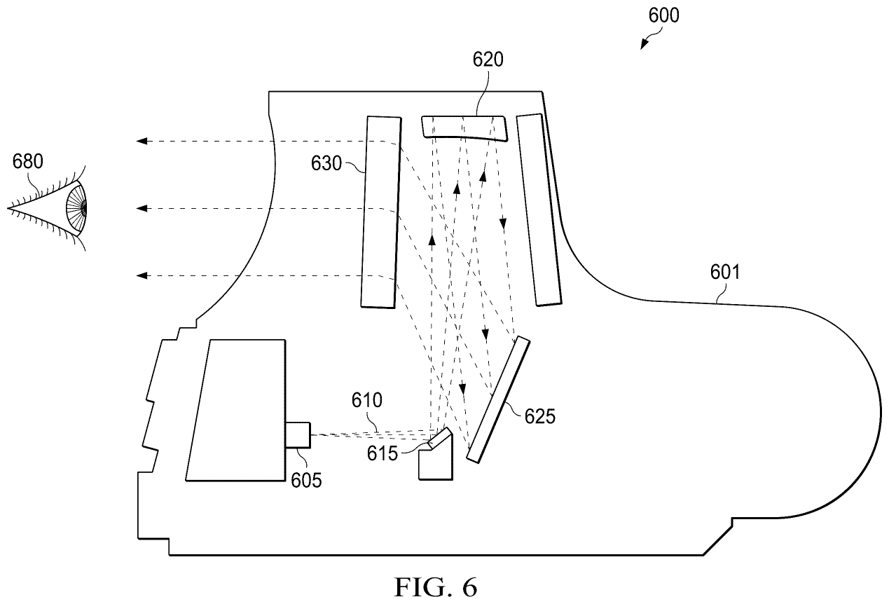

FIG. 6 illustrates a holographic collimator system 600 that can be used to generate an alignment pattern for FOV calibration of an AR display system (e.g., WARD system 100 of FIG. 1) in accordance with some embodiments. The collimator system 600 utilizes multiple optical elements—in the depicted embodiment, a combination of reflective, refractive, and holographic elements—to project a stable and precise alignment pattern into the user's field of view. The manner in which the collimator system 600 directs the display light between its internal optical elements, discussed below, reduces the overall size of the collimator system 600 by compacting the optical pathway and ensuring that the system fits within the constraints of a relatively compact housing 601.

A laser diode 605 serves as the light engine for the depicted embodiment. The laser diode 605 emits a display light 610 that is directed toward a mirror 615. The mirror 615 redirects the emitted light upward to a collimating reflector 620, which aligns and collimates the light rays of the display light 610 into a coherent, parallel beam. The collimating reflector 620 directs this now-coherent display light toward a holographic optical element (grating) 625. As used herein, a holographic grating refers to an optical element that utilizes a holographically recorded pattern to diffract, redirect, or manipulate light in a controlled manner. This pattern, typically encoded within a photosensitive material, interacts with incoming light to produce specific optical effects, such as splitting the light into multiple beams, redirecting its path, or modifying its phase or wavelength distribution. In the context of the collimator system 600 and other embodiments, a holographic grating 625 is used to shape and refine the light path of the display light 610, contributing to the generation of a precise alignment pattern for calibration purposes.

After encountering the holographic grating 625, the processed display light 610 then passes to a reticle image hologram 630, which in the depicted embodiment serves as a graticule for the collimator system 600. The reticle image hologram 630 generates the alignment pattern formed by the processed display light 610—such as crosshairs or other calibration markers—and projects the alignment pattern toward the user 680. This holographically generated alignment pattern provides a precise and stable visual reference, enabling accurate calibration of the AR system's optical components.

By functioning as a holographically implemented graticule, the reticle image hologram 630 offers flexibility in design, allowing for more complex and customizable alignment patterns compared to traditional physical graticules. This compact configuration ensures that the collimator system 600 is suitable for integration into wearable AR devices.

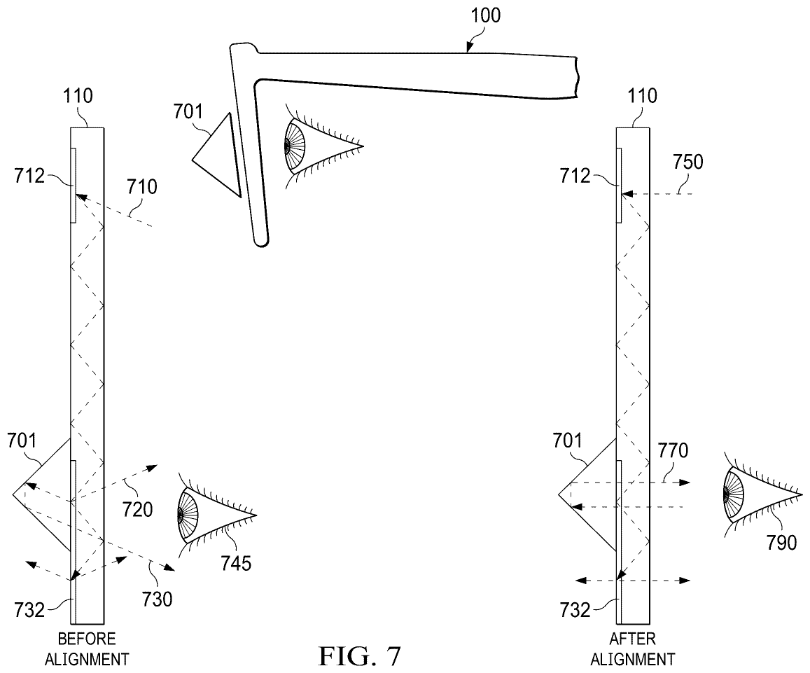

FIG. 7 illustrates an embodiment of a retroreflective-based calibration setup for FOV alignment of an AR display system (not shown), such as the WARD system 100. In the depicted embodiment, a retroreflector (e.g., a prism, film, or other retroreflector) is positioned against a waveguide, which serves as the datum plane for the calibration. This alignment ensures that any deviation from a 0-degree normal incident angle results in a perceptible split of the image, enabling the user to maintain the accuracy and consistency of the AR display's calibration. The use of a retroreflector in this manner simplifies the calibration process and ensures consistent image quality.

As depicted are two configurations, respectively occurring before and after alignment of an input display light beam provided by an AR display system. Both configurations involve input display light beams that are emitted from a light engine (not shown) and received by an incoupler 712 of the lens 110. The lens 110, previously shown in FIG. 1, incorporates an interior waveguide that guides the display light along internally reflective light paths toward an outcoupler 732. A user of the AR display system is enabled by the retroreflector 701 to iteratively align the AR system by adjusting the input beam angle using visual feedback provided by the retroreflector 701.

In the leftmost ‘before alignment’ configuration, an angular misalignment of the input display light beam 710 causes the input display light beam 710 to enter the lens 110 at an angle of incidence that is not normal to the input grating 712. This angular misalignment causes the display light to reflect improperly within the interior waveguide of the lens 110. The misaligned light exits the waveguide at the outcoupler 732 and is directed toward a retroreflector 701. The retroreflector 701 reflects the display light back toward the outcoupler 720; however, due to the initial misalignment, the user's eye 745 perceives a split image caused (in the simplified depiction) by disparate display light beams 720 and 730. This split image visually indicates that the AR display system is not properly aligned.

In contrast, the rightmost configuration ‘after alignment’ shows a corrected input beam 750 that has been realigned to enter the lens 110 at an angle of incidence that is normal to that input grating 712. When so properly aligned, the display light propagates accurately along the interior waveguide of the lens 110, reflecting internally in a controlled manner. The display light exits the waveguide at the outcoupler 732 and is directed toward the retroreflector 701. The retroreflector 701 reflects the light back toward the outcoupler 732, and, because the alignment is correct, the returning display light exits the waveguide with coherent beams directed to the user's eye 790, resulting in a perceived coincident image and confirming that the optical components of the AR display system are properly aligned.

By iteratively adjusting the input display light beam angle—modifying the orientation of the light engine or related components of the AR system—the user can transition from the split image perceived by the user's eye 745 (before alignment) to the coincident image perceived by the user's eye 790 (after alignment). The retroreflector 701 provides intuitive visual feedback that enables precise calibration of the AR system.

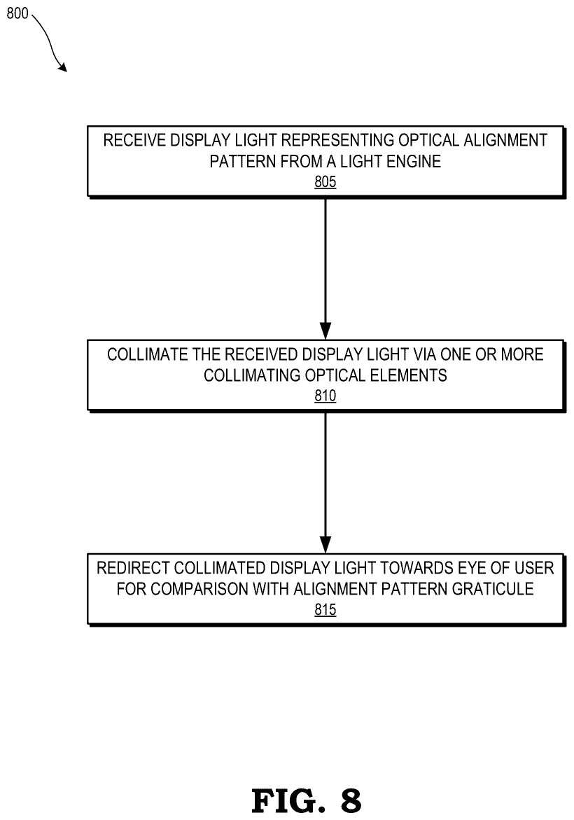

FIG. 8 illustrates an operational routine 800, such as may be performed by a collimating alignment apparatus (e.g., CAA 200 of FIG. 2) in accordance with one or more embodiments. The routine 800 depicts a series of steps for receiving, processing, and redirecting display light representative of an optical alignment pattern to facilitate comparison with a graticule by a user.

At step 805, the collimating alignment apparatus receives display light representing an optical alignment pattern from a light engine, such as a light engine of a wearable AR display system (e.g., the WARD system 100 of FIG. 1). In certain embodiments, the collimating alignment apparatus includes a support frame operable to be removably coupled to one or more such wearable AR display systems having multiple distinct physical parameters.

At step 810, the received display light is collimated via one or more collimating optical elements of the collimating alignment apparatus. These optical elements, which may include one or more retroreflectors, catadioptric lenses, and/or collimating lenses, ensure that the emitted display light forms a coherent and parallel beam.

At step 815, the collimated display light is redirected towards the eye of the user for comparison with an alignment pattern graticule. The graticule provides a stable reference alignment pattern that the user can visually compare to the projected collimated display light. This comparison enables calibration of the AR display system's optical components, ensuring that its field of view is properly aligned.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus, comprising:
a support frame operable to be removably coupled to a wearable augmented-reality display (WARD) system;
a collimator coupled to the support frame and comprising one or more collimating lenses; and
a graticule to align with one or more alignment indicators emitted from the WARD system.

2. The apparatus of claim 1, wherein the support frame is configurable to accommodate multiple distinct wearable augmented-reality display (WARD) systems having multiple distinct physical parameters.

3. The apparatus of claim 1, wherein the collimator comprises one or more retroreflectors.

4. The apparatus of claim 1, wherein the collimator comprises one or more catadioptric lenses.

5. The apparatus of claim 1, wherein the collimator comprises multiple collimating lenses.

6. The apparatus of claim 1, wherein the support frame is operable to be removably coupled to one or more datum surfaces of the WARD system.

7. The apparatus of claim 1, wherein the collimator is configured to be aligned using an optical element of the removably coupled WARD system as a reference plane.

8. The apparatus of claim 1, wherein the collimator is configured to project an alignment pattern towards at least one eye of a user, and wherein the alignment pattern comprises the one or more alignment indicators.

9. The apparatus of claim 8, comprising first and second collimators that are respectively configured to project the alignment pattern towards first and second eyes of the user.

10. The apparatus of claim 9, further comprising one or more user controls to align an instance of the alignment pattern projected towards the first eye of the user with an instance of the alignment pattern projected towards the second eye of the user.

11. The apparatus of claim 1, further comprising a user interface on the support frame for adjusting one or more of a position of the collimator relative to the WARD system or an orientation of the collimator relative to the WARD system.

12. A display system, comprising:
a support frame configured to be worn proximate to an eye of a user;
a light engine coupled to the support frame and operable to emit display light comprising an alignment pattern;
a collimator coupled to the support frame and comprising one or more collimating lenses to direct the display light towards the eye of the user; and
a graticule to align with the alignment pattern.

13. The display system of claim 12, wherein the collimator comprises one or more of a group that includes a retroreflector, a catadioptric lens, or multiple collimating lenses.

14. The display system of claim 12, comprising first and second collimators coupled to the support frame, wherein the first and second collimators are respectively configured to project the alignment pattern towards first and second eyes of the user.

15. The display system of claim 14, further comprising one or more user controls to align a first instance of the alignment pattern projected towards the first eye of the user with a second instance of the alignment pattern projected towards the second eye of the user.

16. The display system of claim 12, further comprising one or more user controls for adjusting one or more of a position of the collimator relative to the light engine or an orientation of the collimator relative to the light engine.

17. The display system of claim 12, wherein the graticule comprises a holographically generated instance of the alignment pattern.

18. A method, comprising:
receiving display light representing an optical alignment pattern from a light engine;
collimating the received display light via one or more collimating optical elements; and
redirecting the collimated display light towards an eye of a user for comparison with a graticule comprising the optical alignment pattern.

19. The method of claim 18, wherein the one or more collimating optical elements and graticule are coupled to a support frame that is operable to be removably coupled to a wearable augmented-reality display (WARD) system that includes the light engine.

20. The method of claim 18, wherein the graticule comprises a holographically generated instance of the optical alignment pattern.
